(19) United States
(12) Patent Application Publication
(10) Pub. No.: US 2005/0228698 A1
(43) Pub. Date: Oct. 13, 2005

(54) Wrist-worn data recorder

(76) Inventors: Howard Edward Smith, Cambridgeshire (GB); Ronald Curtis, Cambridgeshire (GB)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/099,301

(22) Filed: Apr. 5, 2005

(30) Foreign Application Priority Data
Apr. 8, 2004 (GB) 0408086.7

(51) Int. Cl. G06F 17/60

(52) U.S. Cl. 705/2

(57) ABSTRACT

A wrist-worn data recorder is provided that enables the recording of a subjective diary of a user's medical condition. It comprises a processor that receives a clock signal from a clock-signal generator and receives user inputs from a plurality of user-input buttons. Each button corresponds to a predefined condition of the user and is operable by the user to input data relating to their medical condition. The user's inputs are recorded in a memory, from which they are downloadable through an interface. The data recorder further comprises a prompt-signal generator for generating prompt signals at predetermined times, to prompt the user to input data relating to their medical condition.

The invention relates to a wrist-worn data recorder for producing a subjective diary of a user's medical condition, and may be of particular use in the clinical trialling of pharmaceuticals or the diagnosis of illness.

### BACKGROUND OF THE INVENTION

Clinical trials of pharmaceutical products often involve the production of a written diary by a user trialling the pharmaceutical. The written diary may record information such as the presence or absence of a particular symptom in the user and/or the severity of a particular symptom in the user. A diary recording a user's medical condition may also be of use in the diagnosis and treatment of illness. In such an example, a doctor may ask a patient to record a diary of the presence and/or severity of his symptoms in order to aid diagnosis and treatment.

A written diary suffers from the problem that a user needs to be diligent in recording a regular and accurate diary if it is to provide useful information. Diarists often succumb to the temptation to fill in several entries at one time rather than at prescribed times during the day. If this is the case, recollection of the user's condition at each time during the day may not be accurate.

### BRIEF SUMMARY OF THE INVENTION

The invention provides a wrist-worn data recorder and a method for producing a diary of a user's medical condition as defined in the appended independent claims, to which reference should now be made. Preferred or advantageous features of the invention are defined in dependent sub-claims.

Very often, the simplest of responses will provide very useful clinical information. Advantageously, the invention provides a simple data recorder for producing a subjective diary of a user's medical condition, which is particularly suitable for use by the elderly or infirm.

In a first aspect the invention provides a wrist-worn data recorder for recording a subjective diary of a user's medical condition, the data recorder comprising;
a processor;
a clock signal generator coupled to the processor;
a memory coupled to the processor;
a user interface having a plurality of user-input buttons, each button corresponding to a predefined condition of the user for enabling the user to input data relating to the user's medical condition into the memory under the control of the processor;
a prompt-signal generator for generating a prompt-signal in response to an output of the processor to indicate to the user to enter data relating to the user's medical condition; and an interface for reading the data from the memory.

The data recorder is advantageously simply and easily accessible to the user. The use of a wrist-worn recorder combines accessibility of the recorder with user comfort and minimises the chances that the recorder will be forgotten, for example left at home. In order to provide a simple data recorder, the number of user-input buttons is preferably between two and five. Preferably, each user-input button only corresponds to a single discrete condition of the user.

The data stored in the memory can be read by the interface. Preferably, the stored data is uploadable via the interface to an external device for processing and analysis, e.g. by a doctor or by a person leading clinical trials. The interface for transferring data may be a physical means such as an electrical connection or it may be a remote connection such as an infrared transmitter, a radio frequency transmitter, or an inductive link, or it may use mobile phone technology. The external device may be a suitably programmed computer, such as a PC or a PDA (personal digital assistant), or may be a mobile phone, or may be a specialised unit or docking station devoted to the analysis of data from the recorder.

In order to simplify use, the user-input buttons within the user interface are preferably color-coded. The colors may be selected to act as a clear reminder of the meaning of the input button. For example, a green button could indicate that the user is suffering substantially no symptoms and is feeling good, and a red button could indicate that the user is suffering from a given symptom and is not feeling good. If three user-input buttons are present, colors could be selected to be green for no symptom, orange for mild symptom, and red for severe symptom. The use of such colors may provide an intuitive prompt to the user as to the value associated with each input button, thereby aiding them to input meaningful data entries.

In an alternative to color-coding, symbols may be used. Such symbols may be letters or numbers, for example 1, 2, and 3 or A, B, and C, or may be ideograms or pictograms. For example, a smiling face may correspond to an input indicating that the user is feeling well and a grimacing face may correspond to an input indicating that the user is suffering a severe symptom. Advantageously, combinations of colors and symbols may be used.

Advantageously, each user-input button may have to be pressed twice in order to record a data event corresponding to the user's condition to the memory. This requirement may help eliminate false entries being made to the diary. In such a system, the pressing of a button only once or the pressing of two adjacent buttons would not cause a record to be stored in the memory. Preferably, the recorder resets after a predetermined period. Thus, if a button is pressed accidentally once, pressing the same button accidentally again after the recorder has reset will not record data to the memory.

Elderly or infirm users may have considerable difficulty in pressing small input buttons. Therefore it is preferred that the user-input buttons are of a convenient size, for instance, the face of each button preferably has a surface area of greater than 0.5 cm², and particularly preferably greater than 0.75 cm² or greater than 1 cm².

In one embodiment, the recorder may have only two user-input buttons corresponding to two subjective conditions of the user. For example, the buttons may relate to the advantageously simple conditions, “No Symptom” and “Symptom Present.”

In a further preferred embodiment the recorder may have three user-input buttons corresponding to three subjective conditions of the user. For example, the three buttons may relate to the advantageously simple conditions, “No Symptom Present”, “Mild Symptom”, and “Severe Symptom.” The symptom to be recorded may be any predefined symptom of illness or disorder in the user, for example dyskinesia in Parkinson's disease sufferers or users taking anti-psychotic drugs, or may be more generally defined as, for example, a level of discomfort or pain being experienced.

The prompt-signal produced by the recorder may comprise an audible signal, for example an alarm bell or buzzer, a visual signal, for example a flashing light, or a physical signal, such as a vibration signal.

Advantageously, the recorder may produce more than one type of prompt-signal simultaneously. Preferably, both audible and visual prompt-signals are produced simultaneously. This may advantageously allow a user who hears an alarm, to confirm, by visual inspection of the recorder, that the alarm is actually produced by the recorder.

Preferably, the prompt-signal is programmed to be generated for a predetermined prompt-signal time period. This period could be any suitable time, but is preferably between 1 minute and 5 minutes. Advantageously, the prompt-signal may be terminated either by a valid user-input or at the end of the prompt-signal time period.

The recorder may be programmed to accept data entries at any time, for example if the user feels an acute symptom. Alternatively, the recorder may be programmed to only accept a diary entry during a predetermined input-period after the start of each prompt-signal. For example, it may only be possible to make a diary entry within, say, an input-period of five minutes from the prompt-signal first being produced.

Advantageously, the input period and the prompt-signal time period may be the same period, and a valid diary entry may be made at any time that the prompt-signal is being produced. Advantageously, a valid data entry may cause the termination of the prompt-signal.

Preferably, the recorder can be programmed to produced a prompt-signal at any predetermined time or at any predetermined time interval. For example, a prompt-signal may be generated every 30 minutes, to prompt the user to make a data entry every 30 minutes. Preferably, such a prompt-signal would be terminated after a valid user data entry or after the passing of a predetermined prompt-signal period.

In addition to user-input buttons, the recorder may additionally comprise an “On/Off” button. Such a button would allow the user to turn the recorder off, for example if they were entering a zone where noise may be undesirable. Preferably, On/Off actuation would be by means of a prolonged depression of the “On/Off” button. A particularly preferred embodiment of the recorder may therefore comprise four buttons, these buttons being one “On/Off” button and three user-input buttons.

In some applications, it may be advantageous to record an indication of the physical activity of the user. Advantageously, an accelerometer may be incorporated into the recorder and record data representing activity of the user to the memory. This activity data may then be downloaded and processed in conjunction with the diary entry data on the external device.

In a further aspect, the invention provides a method of producing a subjective diary of a user's medical condition comprising the steps of;
arranging for a wrist-worn recorder comprising a prompt-signal generator to produce prompt-signals at predetermined times;
in response to each prompt-signal, the user pressing one of a plurality of user-input buttons of the recorder to record data relating to the user's medical condition to a memory of the recorder; and,
subsequently reading the data.

The predetermined times, which may be at predetermined time intervals, at which prompt-signals are produced are preferably set by a doctor or person setting up clinical trials. The wrist-worn recording device would be programmed with the appropriate predetermined times and then supplied to the user. The user may be a patient or a person trialling a particular pharmaceutical. The user presses a user-input button in response to each prompt-signal causing data relating to the user's condition at that time to be logged to the memory.

Preferably, there are between 2 and 5 user-input buttons and each user-input button may need to be pressed twice in response to the prompt-signal in order for the data to be logged. As described above, this may prevent erroneous details from being logged to the memory.

Advantageously, the prompt-signal may be terminated when the recorder receives a user-input. Thus, an annoying alarm will not sound once the user has entered the required information. Preferably, the prompt-signal is produced for a predetermined period and if no user-input is provided within this period the lack of input is logged to the memory and the signal is terminated. This predetermined time may be any suitable time, for example, between 1 and 5 minutes. The time limit would be set to allow the user adequate time to make his diary entry. If no input is received within the time limit, this information is logged to the memory and the signal is terminated. Such an event may indicate that the recorder is not being worn by the user, or that the user cannot hear the prompt-signal.

In a third aspect the invention provides a body-worn or wearable data recorder for recording a subjective diary of a user's medical condition. Such a wearable data recorder has the technical features as described above but is wearable by the user in an area other than on the wrist, for example around the user's neck or clipped to a user's belt.

### BRIEF DESCRIPTION OF THE DRAWINGS

FIG. 1 is a front elevation of a wrist-worn data recorder according to an embodiment of the invention.

FIG. 2 is a side elevation of the recorder of FIG. 1.

FIG. 3 is a rear elevation of the recorder of FIG. 1.

FIG. 4 is a block diagram illustrating the main functional components of the recorder of FIG. 1.

FIG. 5 is a flow diagram illustrating the method steps required to communicate between the recorder of FIG. 1 and an external device.

FIG. 6 is a flow diagram illustrating the method steps required to record data to a memory in the recorder of FIG. 1.

### DETAILED DISCLOSURE OF THE INVENTION

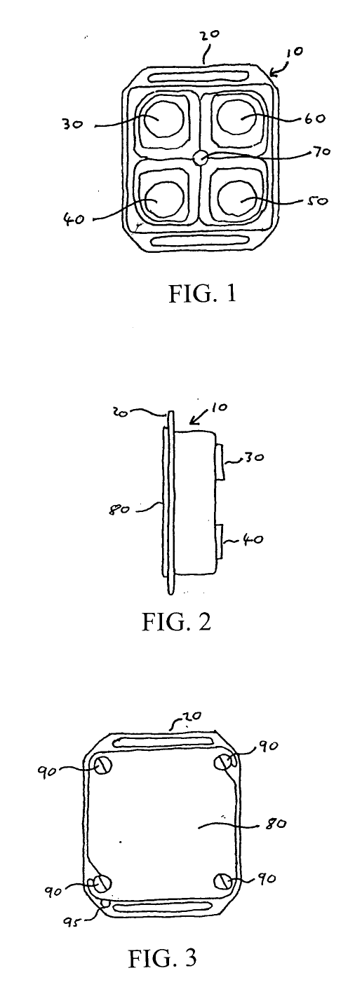

Specific embodiments of the invention will now be described by way of example, with reference to the accompanying drawings, in which FIGS. 1, 2 and 3 illustrate front, side, and rear elevations of a preferred embodiment of a wrist-worn data recorder according to the invention.

The recorder comprises a housing 10 with attachment points 20 for attaching to a wrist-strap or band. The strap or band allows the recorder to be worn on a user's wrist. Four color-coded buttons 30, 40, 50, and 60, and a light-emitting diode (LED) 70 are arranged on a front surface of the housing. A rear surface of the housing has a backing plate 80 held in place by screws 90. The rear surface of the housing also has an alignment notch or hole 95, for assisting in the alignment of the recorder with an external reader.

Button 30 is an On/Off button, colored blue, and allows the recorder to be switched on or off by the user. Buttons 40, 50, and 60 are user-input buttons colored green, orange and red respectively, and each button relates to a particular condition of the user. LED 70 forms part of a prompt-signal, and flashes at predetermined times to prompt the user to record an entry on one of the three user-input buttons.

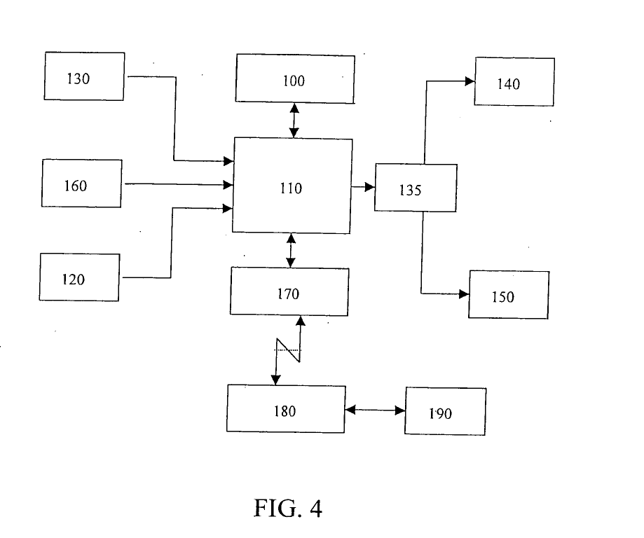

FIG. 4 illustrates the operative components of the data recorder, housed in the housing.

The recorder includes a memory 100, which stores timing information and data input by the user. The flow of data to be written to, or read from, the memory is controlled by a processor 110. The processor receives inputs from a clock signal generator 120 and a user interface 130 and controls the writing of information to the memory and the reading of information from the memory. The user interface comprises a plurality of buttons; in this particular embodiment the user interface comprises the three user-input buttons 40, 50, 60, for enabling the user to input data relating to the user's medical condition to the memory, and one On/Off button 30. The processor also controls a prompt-signal generator 135, which generates visual and audible prompt-signals simultaneously via a visual display means 140 and a transducer 150. In this embodiment the visual display is the LED 70, although it may be any form of light emitting device or other visual indicator. The transducer produces an audible signal, although a different embodiment may produce a vibratory signal in addition to or instead of the audible signal.

The data recorder also includes an accelerometer 160 for producing user activity data. Activity data produced by the accelerometer is written to the memory via the processor.

The data recorder is powered by a battery housed in the housing.

The data recorder has an interface 170 for coupling the processor to an external device, thereby allowing the recorder to be programmed and allowing data from the memory to be downloaded from the recorder. The data recorder interface 170 couples to an external device interface 180, which allows data to be transferred to and from an external device 190. The coupling between the recorder interface 170 and the external device interface 180 is preferably a wireless coupling, such as a radio frequency or an inductive coupling, although alternative embodiments may use a wired coupling. In a particularly advantageous embodiment, data from the recorder may be downloaded to an external device, such as a computer, in a surgery or laboratory via a telephone link.

Although the external device 190 is likely to be a computer such as a PC, any suitable data-processing means may be used, for example, a dedicated data-logging or processing unit.

In this embodiment, the recorder interface 170 and the external device interface 180 are inductive interfaces, and the external device interface is housed within a reader and coupled to a computer such as a PC.

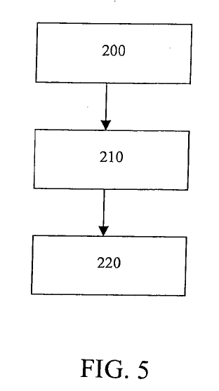

FIG. 5 is a flow diagram, in which each box represents a step involved in communicating with the reader.

In order to communicate with the reader, the data recorder is first placed on a docking portion of the reader (step 200). The position of the recorder is then adjusted until correct alignment is indicated by illumination of the LED (step 210). Correct alignment is aided by the presence of an alignment notch 95 in the recorder housing, which indicates the correct orientation of the recorder relative to the docking portion of the reader. Illumination of the LED indicates that the recorder is coupled to the reader and is ready for communication with the reader.

Correct alignment of the recorder with the reader allows data to be written to, or read from, the recorder via the inductive coupling. Data transfer is then initiated, either from the recorder to the external device, or from the external device to the recorder (step 220).

The data recorder is programmed by a user using software running on the external device. The software allows inputs for the following defined user settings.
User identity.
Gender.
Age.
Start date and start time—by default these are the current date and time of the external device. The recorder can be set to start recording up to 40 days in the future.
Interval—this is the frequency with which the user will be prompted to enter a score. An example of a typical interval is every 30 minutes.

When the parameters have been entered correctly on the external device, this information can be transferred to the data recorder. A confirmation screen appears on the external device to indicate when the data transmission has been completed.

To read data from the data recorder the recorder is again placed on the reader (step 200) and adjusted until the LED light appears indicating correct alignment of the recorder with the reader (step 210). Selecting a read option on the external software causes the data to be transferred from the data recorder to the external device (step 220).

The recorder can be programmed to produce a prompt-signal, both audibly and visually, at any predetermined time or time interval, for example every thirty minutes. The times will depend on the requirements of the doctor or clinician who will use the data collected by the diary.

In this particular embodiment, the prompt-signal is programmed to sound for a predetermined prompt-signal period of 4.25 minutes, although this period could be any suitable period. If at the end of this period no user-input is provided, this fact is noted and the prompt-signal is terminated.

The three user-input buttons each correspond to a predetermined medical condition of the user. The user is made aware of which button to press depending on his state when the prompt-signal is produced. For example, in a recorder for producing a diary of a user's dyskinesia, perhaps in response to taking an anti-psychotic drug or as a symptom of Parkinson's disease, the green button would be depressed if the user had no symptoms of dyskinesia, the orange button would be pressed if the user had mild symptoms of dyskinesia, and the red button would be pressed if the user had severe symptoms of dyskinesia.

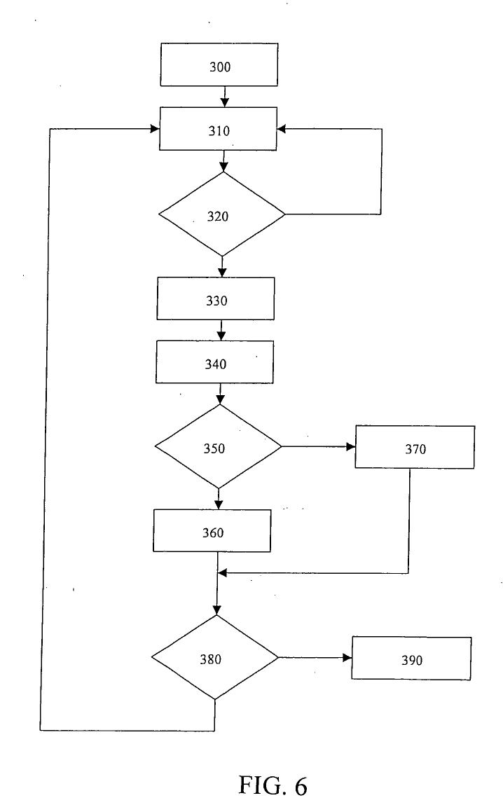

FIG. 6 illustrates the steps involved in collecting data and recording the data to the memory in the preferred embodiment. These are as follows.

Step 300—Programming information, including the prompt-signal interval, is uploaded to the recorder.

Step 310—The processor 110 queries the system clock 120 for timing information.

Step 320—Is it time to emit a prompt-signal? If no, return to step 310. If yes go to step 330.

Step 330—The processor communicates with the prompt-signal generator 135, which generates prompt-signals from both the transducer 150 and the LED 140.

Step 340—The processor queries the user interface 130 and the system clock 120.

Step 350—Is a valid user-input received within a predetermined prompt-signal period? If yes go to 360. If no, go to 370.

Step 360—The processor records the user-input to the memory 100, and the prompt-signal is terminated.

Step 370—The processor records the lack of user-input to the memory 100, and the prompt-signal is terminated.

Step 380—Is more data required? The recorder may be pre-programmed to record a certain number of data entries, or to record data for a predetermined time, or until the memory is full. If yes go back to step 310. If no go to step 390.

Step 390—End data collection.

It should be understood that the examples and embodiments described herein are for illustrative purposes only and that various modifications or changes in light thereof will be suggested to persons skilled in the art and are to be included within the spirit and purview of this application and the scope of the appended claims.

1. A wrist-worn data recorder for recording a subjective diary of a user's medical condition, the data recorder comprising;
a processor;
a clock-signal generator coupled to the processor;
a memory coupled to the processor;
a user interface having a plurality of user-input buttons, each button corresponding to a predefined condition of the user for enabling the user to input data relating to the user's medical condition into the memory under the control of the processor;
a prompt-signal generator for generating a prompt signal in response to an output of the processor to indicate to the user to enter data relating to the user's medical condition; and
an interface means for reading the data from the memory.

2. The recorder according to claim 1, comprising between 2 and 5 user-input buttons.

3. The recorder according to claim 1, in which the user-input buttons are color-coded.

4. The recorder according to claim 1, in which each user-input button has to be pressed twice in order to record data relating to the user's medical condition to the memory.

5. The recorder according to claim 1, in which each user-input button has a surface area of greater than 0.5 cm².

6. The recorder according to claim 1, comprising three user-input buttons corresponding respectively to the following three subjective conditions of the user;
1) No Symptom
2) Mild Symptom
3) Severe Symptom.

7. The recorder according to claim 1, comprising two user-input buttons corresponding respectively to the following two subjective conditions of the user;
1) No Symptom
2) Symptom Present

8. The recorder according to claim 1, in which the prompt signal produced by the prompt-signal generator is audible.

9. The recorder according to claim 1, in which the prompt signal produced by the prompt-signal generator is visual.

10. The recorder according to claim 1, in which the prompt signal produced by the prompt-signal generator is vibratory.

11. The recorder according to claim 1, wherein the prompt signal generator produces both audible and visual prompt signals simultaneously.

12. The recorder according to claim 1, additionally comprising an accelerometer for recording activity data to the memory under the control of the processor.

13. The recorder according to claim 1, in which the prompt signal is generated for a predetermined time period and is terminated in response to a valid user input or at the end of the predetermined time period.

14. The recorder according to claim 1, which is programmable to generate a prompt-signal at any predetermined time or time interval.

15. A method of producing a subjective diary of a user's medical condition comprising the steps of;
arranging for a wrist-worn recorder comprising a prompt-signal generator to produce prompt-signals at predetermined times;
in response to each prompt-signal, the user pressing one of a plurality of user-input buttons of the recorder to record data relating to the user's medical condition to a memory of the recorder; and,
subsequently reading the data.

16. The method according to claim 15, in which the recorder comprises between 2 and 5 user-input buttons.

17. The method according to claim 15, wherein any one of the plurality of user-input buttons must be pressed twice in response to a prompt-signal in order for data to be stored.

18. The method according to claim 15, wherein in response to the user experiencing no symptom a first button is pressed, in response to the user experiencing a mild symptom a second button is pressed and in response to the user experiencing a severe symptom, a third button is pressed.

19. The method according to claim 15, wherein a prompt-signal is terminated when the recorder receives a user-input.

20. The method according to claim 15, wherein a prompt-signal is produced for a predetermined period and if no user-input is provided within that period, this lack of input is logged to the memory and the signal is terminated.
